(19) United States
(12) Patent Application Publication
(10) Pub. No.: US 2025/0328512 A1
(43) Pub. Date: Oct. 23, 2025

(54) DATABASE DATA ACQUISITION

(71) Applicant: Growers Tech Inc., Creve Coeur, MO (US)

(72) Inventors: Etzik BEGA, Modi'in-Maccabim-Re'ut (IL); Dan RAUDNITZ, Hod Hasharon (IL)

(21) Appl. No.: 19/068,158

(22) Filed: Mar. 3, 2025

(30) Foreign Application Priority Data
Apr. 18, 2024 (IL) 312271

(51) Int. Cl. G06F 16/22

(52) U.S. Cl. CPC G06F 16/2255

(57) ABSTRACT

A pipeline for data ingestion to a database comprises an index-generating component based on a deterministic function, and a comparison component adapted to determine if an index generated by said index-generating component already exists in said database.

### FIELD OF THE INVENTION

The present invention relates to the structure and operation of database ingestion pipelines. More particularly, the invention relates to the significant reduction of ingestion times to databases, such as, for example, graph databases, while at the same time avoiding index duplications.

### BACKGROUND OF THE INVENTION

A significant challenge arises in modern data management systems when ingesting data from diverse sources such as CSV files, JSON files, and online sources into graph databases. This process frequently encounters the substantial problem of node duplication, leading to inconsistencies and inefficiencies in data management. Optimizing data ingestion procedures is critical in addressing these challenges, especially for graph databases, where ensuring data integrity is paramount for accurate queries, analytics, and downstream applications. For example, duplicate nodes can lead to inaccurate relationships and analysis, impacting graph databases' operational efficiency and overall reliability.

Despite the importance of addressing node duplication, traditional solutions such as cross-processing communication, graph database locking, or post-ingestion duplication removal often prove inadequate. These approaches may be impractical to implement, require significant processing time, or fail to address the problem comprehensively. Notably, as the size and complexity of the graph escalate, the limitations of existing solutions become more pronounced.

When faced with custom data in a graph database, the challenge lies in seamlessly integrating this data. This involves creating new nodes, adding new properties to existing nodes, and establishing links between these existing nodes and the newly created ones.

The common approach to prevent the duplication of nodes with the same index requires operating the pipeline to the database (also referred to hereinafter as “the conventional pipeline”) according to the following steps:

### 1. Index Assignment:

1.1 Manage a list that assigns new indexes to the new nodes.
1.2 During custom data processing, the service checks if a node already exists based on its attributes;
1.3 If the node exists, the service uses the existing node index for its purposes (properties and links);
1.4 If the node doesn't exist, a new index is created based on the nodes' attributes, typically assigned sequentially (1, 2, 3 . . . ).

### 2. Locking Mechanism:

2.1 During the creation of a new node, the graph database is locked to prevent simultaneous use of the same index by other processes;
2.2. The new index is added to the list with the relevant attributes and is used for the following object ingestion.

However, the index search and graph database locking processes consume a significant amount of time and impede the parallelism of the ingestion process.

### SUMMARY OF THE INVENTION

The invention relates to the structure of a pipeline for data ingestion to a database, comprising an index-generating component based on a deterministic function and a comparison component adapted to determine if an index generated by said index-generating component already exists in said database.

In one specific embodiment of the invention, the deterministic function is a hash function. In another embodiment of the invention, the database is a graph database.

The invention also encompasses a method for ingesting data into a database, comprising generating the index of the data being ingested by applying a deterministic function to the data's attributes and ingesting the data if the index generated is unique in the database.

### BRIEF DESCRIPTION OF THE DRAWINGS

In the drawings:

FIG. 1 schematically illustrates the operation of a system according to one embodiment of the invention;

FIG. 2 illustrates the structure of a conventional pipeline used in the comparison example of this specification; and

FIG. 3 illustrates the structure of a pipeline according to an embodiment of the invention, as used in the comparison example.

### DETAILED DESCRIPTION OF THE INVENTION

The invention employs a deterministic function, such as hash, to assign the new data's index for data ingested into the database. In simplified terms, instead of managing a list that holds the existing indexes and their attached data and a service that assigns and manages the indexes, the index is assigned directly based on the data itself.

When using a deterministic function (Hash), the same data will always lead to the same result. When that result is used as the index, the danger of duplication is eliminated. This also removes the need for the index assignment service.

The invention eliminates the need for the locking mechanism of conventional pipelines, meaning file ingestion can be performed simultaneously and independently, dramatically improving the ingestion time and eliminating the chance of duplication.

The flow of the data acquisition in a specific embodiment of the invention, using a hash function, can be described as follows:
a) During custom data processing, the indexes are generated directly from the data values using a hash algorithm; and
b) Nodes and properties are created/merged directly using the hash calculated without the need to be synced with processing done in parallel.

To avoid collisions, the deterministic function size should be big enough compared to the number of nodes in the database.

The probability for collision can be calculated by the birthday paradox equation:

$$P ( collision ) = 1 - \frac{d}{d} \times \frac{d - 1}{d} \times \frac{d - 2}{d} \times … \times \frac{d - n + 1}{d}$$

where:
d: is the deterministic function size, and
N: is the number of nodes

For example, when using a hash function as the deterministic function, the collision probability can be determined according to:

$$P ( collision ) = 1 - \frac{hash space size}{hash space size} \times \frac{hash space size - 1}{hash space size} \times \frac{hash space size - 2}{hash space size} \times … \times \frac{hash space size - ( n - 1 )}{hash space size}$$

The above illustrates the very low probability that operating according to the invention may result in a collision when acquiring data. For example, for a 128-bit hash (space size of 2\hat{ }128) and 1,000,000,000 nodes, the collision probability is ≈1.857482185e-15.

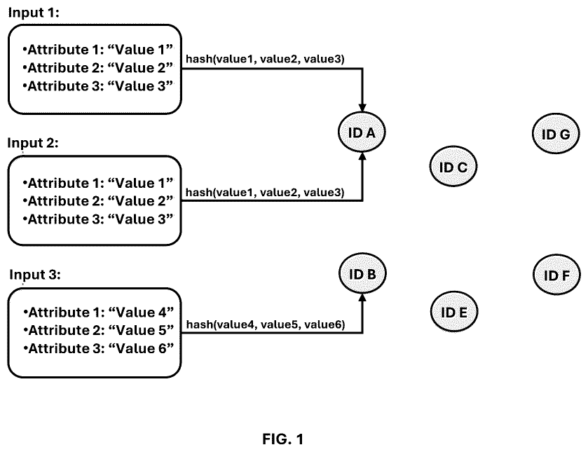

The operation of the invention is schematically illustrated in FIG. 1. The figure shows data being ingested by the graph database, which has a plurality of indexes (symbolized by UD a through ID G). In this illustrative example, the hash of the values of the attribute of Input 3 is unique; therefore, that value becomes a new index ID B. In contrast, the hash value of Input 2 is identical to that of previously created Input 1, i.e., both result in ID A, and therefore, Input 2 is discarded.

As will be apparent to the skilled person, the invention provides a simple and yet highly robust way to allow simultaneous ingestions to the database without the worry of node duplication. This speeds up dramatically the ingestion process since each of the processing functions runs independently of the parallel processing done at the same time. The invention thus saves time, improves the user experience, saves costs, and ensures the graph database's accuracy and integrity.

The man of the art will appreciate another important advantage of the invention, which is its scalability. When operating according to the invention, the graph size does not affect the process so that systems can grow, and the performance will remain the same.

### Implementation Example

To illustrate the invention, a comparison was made between the ingestion pipeline of agriculture data and a graph database, comparing a conventional pipeline and a pipeline according to the invention.

### Conventional Pipeline Overview:

Due to the need to ingest data in parallel and the high processing time caused by the problem, the original pipeline was divided into several processing steps. Each step was responsible for the specific data processing required for the agronomic data used in the comparison. A queue was added between every two functions to manage the load and parallel processing. The pipeline was implemented on the AWS public cloud using AWS lambda functions for processing and AWS sqs for queue. The last function pushed the data to the graph DB.

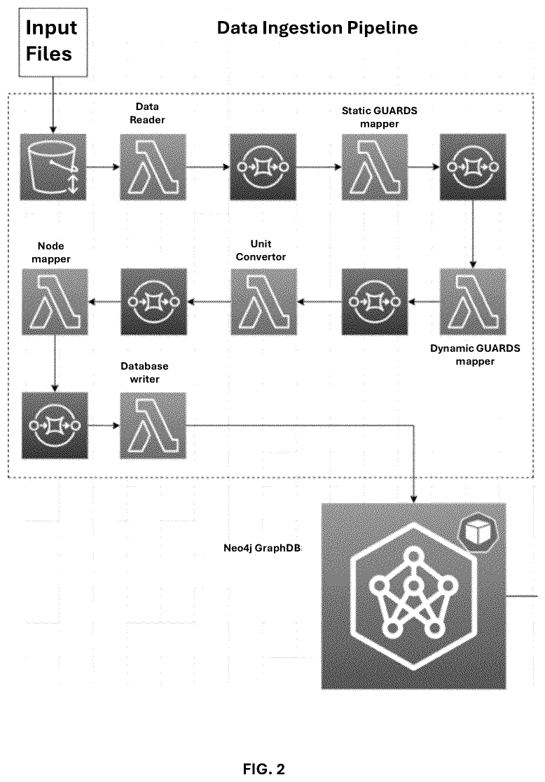

The flow is described in the diagram of FIG. 2. The pipeline is triggered once a file is uploaded to the bucket. The file contains agriculture data that needs to be ingested to the DB. Once the file is uploaded to the bucket, a function called “Data Reader” (hosted on AWS lambda function) is triggered (Step 1). This function reads the file, validates its format and correct structure, and then separates the data into individual data objects. These objects are pushed to a queue (AWS SQS) for the next step.

Step 2—In this step, objects are pulled from the queue and converted to the selected Agmatix taxonomy (referred to hereinafter as “Agmatix taxonomy”) as part of standardization. Converted objects are pushed to the queue for the next step.

Step 3—This step converts objects custom-created by the user and not part of the original Agmatix Taxonomy. Converted objects are pushed to the queue for the next step.

Step 4—In these steps, units are converted to the same scale as part of standardization.

Step 5—These steps create the relationships between all data nodes as part of Agmatix's data model.

Step 6—This is the final step in the pipeline, where the data is pushed to the graph DB.

### New Pipeline:

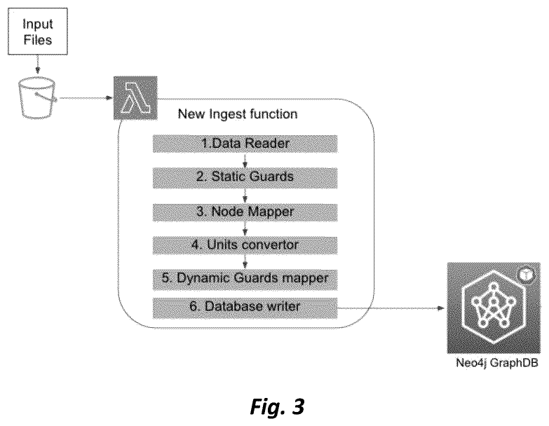

The new pipeline is schematically described in FIG. 3.

Similar to the previous pipeline, the pipeline is triggered once a file is uploaded to the bucket.

The file upload triggers an AWS lambda function that processes the agronomic data in the file, prepares it for ingestion, and then pushes it to the graph DB.

All the different steps are done internally in the same function without the need to separate them into different AWS lambdas functions and create a queue between them.

With the implementation of the invention, all processing steps are seamlessly consolidated within a single function. This simplification of the cloud architecture yields numerous benefits. Notably, it reduces the intricacies associated with deployment and operational tasks, streamlines monitoring functionality, ensures optimal performance, and reduces overall cost. The elegance of a simpler cloud architecture introduced by the invention translates into enhanced efficiency, operational ease, and substantial cost savings.

### Comparative Experimental Run

Four files above 6 MB were selected for the comparison, each containing several thousands of nodes.

Each file was ingested twice, once using the conventional pipeline and then the pipeline operating according to the invention.

The results can be seen in Table 1 below.

TABLE 1

| File No. | Size | | Prior Art | The Invention |
|---|---|---|---|---|
| 4841 | 6.3 | MB | 12 min | 3:01 min |
| 4836 | 6.3 | MB | 18 min | 2:42 min |
| 4848 | 9.4 | MB | 24 min | 4:05 min |
| 4849 | 18.2 | MB | Failed- wasn't | 7:39 min |
| | | | able to finish. | |

It is important to note that according to the prior art, the files were ingested one by one with a 10-minute interval between each file. In contrast, according to the invention, they were ingested in parallel, and thus, after 7:39 min, all four files were ingested. As can be readily appreciated, the difference between the prior art and the invention is dramatic.

Among the many advantages of the invention, it should be noted that the conventional pipeline not only necessitates longer processing time but also requires a more complex architecture than the invention to accommodate large files and scalability. The invention allows the streamlining of the pipeline architecture, consolidating from 6 cloud functions (AWS Lambda) and five queues (AWS SQS) to a single cloud function.

All the above description and examples have been provided for the purpose of illustration and are not intended to limit the invention in any way. The improved pipeline of the invention can be used in a variety of databases and environments for different data types, all without exceeding the scope of the invention.

1. A pipeline for data ingestion to a database, comprising an index-generating component based on a deterministic function, and a comparison component adapted to determine if an index generated by said index-generating component already exists in said database.

2. A pipeline according to claim 1, wherein the deterministic function is a hash function.

3. The pipeline of claim 1, wherein the database is a graph database.

4. A method for ingesting data into a database, comprising generating the index of the data being ingested by applying a deterministic function to the data's attributes, and ingesting the data if the index generated is unique in the database.

5. The method of claim 4, wherein the deterministic function is a hash function.
